(19) United States
(12) Patent Application Publication
(10) Pub. No.: US 2026/0045738 A1
(43) Pub. Date: Feb. 12, 2026

(54) LEVER-EQUIPPED CONNECTOR, CONNECTOR ASSEMBLY AND ASSEMBLY METHOD

(71) Applicant: SUMITOMO WIRING SYSTEMS, LTD., Mie (JP)

(72) Inventors: Stefan LEWOSKI, Mie (JP); Ryousuke GIGA, Mie (JP)

(21) Appl. No.: 19/288,037

(22) Filed: Aug. 1, 2025

(30) Foreign Application Priority Data
Aug. 8, 2024 (JP) 2024-133245

(51) Int. Cl. H01R 13/629; H01R 43/26

(52) U.S. Cl. CPC H01R 13/62944; H01R 13/62955; H01R 43/26

(57) ABSTRACT

A gear mechanism provided in a lever-equipped connector includes an inner gear and an outer gear formed in a lever. In the gear mechanism, the inner gear is meshed with a first gear rotatably or pivotably provided in a connector housing and the outer gear is meshed with a second gear rotatably or pivotably provided in the connector housing. The first gear includes a first engaging piece to be meshed and engaged with an inner side of a first engaged portion of a mating connector when the lever is rotated to a connection position. The second gear includes a second engaging piece to be meshed and engaged with an inner side of a second engaged portion of the mating connector when the lever is rotated to the connection position.

### CROSS-REFERENCE TO RELATED APPLICATIONS

This application is based on and claims priority from Japanese Patent Application No. 2024-133245, filed on Aug. 8, 2024, with the Japan Patent Office, the disclosure of which is incorporated herein in its entirety by reference.

### TECHNICAL FIELD

The present disclosure relates to a lever-equipped connector, to a connector assembly and an assembling method.

### BACKGROUND

Conventionally, a connector assembly configured to completely connect a first connector to a second connector by rotating a lever of the first connector connected to the second connector is known as disclosed in EP 2274800 B1. The first connector includes a drive gear provided on the lever and a connection gear configured to rotate, following this drive gear. If the lever is rotated, the drive gear and the connection gear rotate in directions opposite to each other. At this time, a lever robe of the drive gear and a lever robe of the connection gear are engaged with cam tracks respectively formed on the second connector, whereby the first connector is completely connected to the second connector.

### SUMMARY

In the case of EP 2274800 B1, since the drive gear is integrally formed to the lever, the drive gear is directly rotated by an operation force of a lever rotating operation. On the other hand, since the connection gear is meshed with the drive gear, the connection gear is rotated by indirectly receiving the operation force of the lever rotating operation via the drive gear. In this way, rotation loads of the drive gear and the connection gear are not equal when the lever is rotated, wherefore the first connector is possibly obliquely connected to the second connector. On the other hand, such a connector assembly using a gear structure for connector connection also has a high need for size reduction.

The present disclosure aims to provide a lever-equipped connector, a connector assembly and an assembling method capable of making oblique connection to a mating connector less likely to occur and reducing a connector size.

This object is solved according to the invention by the features of the independent claims. Particular embodiments of the invention are subject of the dependent claims.

According to one aspect, there is provided a lever-equipped connector, comprising: a connector housing to be connected to a mating connector; a lever displaceably (particularly rotatably or pivotably) provided on the connector housing, the lever-equipped connector being connectable or connected to the mating connector if the lever is displaced (particularly rotated or pivoted) from a connection initial position to a connection position; and a gear mechanism including an inner gear formed in the lever such that teeth substantially are arrayed along a lever displacement direction and an outer gear formed in the lever to integrally or unitarily move with the inner gear, the inner gear being meshed with a first gear movably (particularly rotated or pivoted) provided in the connector housing, the outer gear being meshed with a second gear movably (particularly rotated or pivoted) provided in the connector housing.
the first gear including a first engaging piece to be meshed and engageable or engaged with a first engaged portion of the mating connector when the first gear is moved (particularly rotated or pivoted) by the inner gear in an operation of locating the lever at the connection position.
the second gear including a second engaging piece to be meshed and engageable with a second engaged portion of the mating connector when the second gear is moved (particularly rotated or pivoted) by the outer gear in the operation of locating the lever at the connection position.

According to a particular embodiment, the first engaging piece is to be meshed and engageable or engaged with an inner side of the first engaged portion of the mating connector when the first gear is moved (particularly rotated or pivoted) by the inner gear in an operation of locating the lever at the connection position, and/or the second engaging piece to be meshed and engageable or engaged with an inner side of the second engaged portion (27) of the mating connector when the second gear is moved (particularly rotated or pivoted) by the outer gear in the operation of locating the lever at the connection position.

According to a particular embodiment, a lever-equipped connector for solving the above problem is provided with a connector housing to be connected to a mating connector, a lever rotatably or pivotably provided on the connector housing, the lever-equipped connector being connected to the mating connector if the lever is rotated from a connection initial position to a connection position, and a gear mechanism including an inner gear formed in the lever such that teeth are arrayed along a lever rotation direction and an outer gear formed in the lever to integrally rotate with the inner gear, the inner gear being meshed with a first gear rotatably or pivotably provided in the connector housing, the outer gear being meshed with a second gear rotatably or pivotably provided in the connector housing, the first gear including a first engaging piece to be meshed and engaged with an inner side of a first engaged portion of the mating connector when the first gear is rotated by the inner gear in an operation of locating the lever at the connection position, and the second gear including a second engaging piece to be meshed and engaged with an inner side of a second engaged portion of the mating connector when the second gear is rotated by the outer gear in the operation of locating the lever at the connection position.

According to the above, both the first engaging piece to be engaged with the first engaged portion of the mating connector and the second engaging piece to be engaged with the second engaged portion of the mating connector are formed on driven gears (first gear, second gear) configured to co-move (particularly co-rotate or co-pivot) with the lever. Thus, when the lever is displaced (particularly rotated or pivoted) toward or to the connection position, a difference in movement load (particularly rotation load or pivoting load) is hardly generated between the first engaging piece to be engaged with the first engaged portion by moving (particularly rotating or pivoting) together with the first gear and the second engaging piece to be engaged with the second engaged portion by moving (particularly rotating or pivoting) together with the second gear. In this way, the first and second engaging pieces are engaged with the mating partners with equivalent loads, wherefore the lever-equipped connector is hardly connected in an inclined state to the mating connector.

Specifically, the first and second gears need to be moved (particularly rotated or pivoted) in directions substantially opposite to each other to engage the first engaging piece with the inner side of the first engaged portion and engage the second engaging piece with the inner side of the second engaged portion. At this time, if the first and second gears are both configured to be meshed with outer teeth of the lever, either one of the first and second gears needs to be meshed with the outer teeth via another gear and a concern for enlargement arises. On the other hand, in the case of this configuration, the first gear particularly is meshed with the inner gear of the lever. Thus, the number of gears is not increased, wherefore the lever-equipped connector can be reduced in size. In the above way, oblique connection to the mating connector can be made less likely to occur and the connectors can be reduced in size.

Particularly, the first engaging piece is arranged inside the first gear, and/or the second engaging piece is arranged inside the second gear.

According to the above, an engaged part of the first engaging piece and the first engaged portion particularly can be at least partly covered by a meshed part of the inner gear of the lever and the first gear, in other words, by a side wall of the lever. Similarly, an engaged part of the second engaging piece and the second engaged portion can be at least partly covered by a meshed part of the outer gear of the lever and the second gear, in other words, by the side wall of the lever.

Thus, a connected part of the mating connector and the connector housing can be covered by the side wall of the lever, wherefore the intrusion of an external matter or water into the connector can be made less likely to occur.

Further particularly, the first gear is at least partly accommodated in a first recess formed in an inner surface of the lever, and/or the second gear is at least partly accommodated in a second recess formed in the inner surface of the lever.

According to the above, sizes in a lever axial direction (specifically, a thickness direction) can be reduced, therefore contributing to the size reduction of the lever-equipped connector in this direction.

Further particularly, the lever includes at least one reinforcing portion formed to couple the inner gear to a lever body on a side of the first gear to improve strength of the inner gear.

According to the above, since the strength of the inner gear can be enhanced by the reinforcing portion, an abnormality can be made less likely to occur in the inner gear.

Further particularly, the lever-equipped connector is provided with at least one lock mechanism for locking displacement (particularly the rotation or pivoting) of the lever by at least one lock portion of the lever engaging or being engageable a lock engaging portion of the connector housing when the lever is operated to the connection position.

Further particularly, the lock portion is engaged with a position holding portion of the connector housing to hold the lever at the connection initial position when the connector housing is not connected to the mating connector and enables the lever to be displaced (particularly rotated or pivoted) to the connection position by being released from a position holding state by the position holding portion by a releasing portion of the mating connector in the process of connecting the connector housing to the mating connector.

According to the above, before the lever-equipped connector is connected to the mating connector, the lever can be held at the connection initial position by the lock mechanism. Thus, before the lever-equipped connector is attached to the mating connector, the lever is hardly accidentally displaced (particularly rotated or pivoted) in a connection direction. This contributes to an improvement in workability in connecting the lever-equipped connector to the mating connector.

Further particularly, the lever-equipped connector further includes a connection position assurance member for assuring a connected state of the connector housing with the mating connector.

According to another aspect of the invention, there is provided a connector assembly comprising a lever-equipped connector according to the above aspect or a particular embodiment thereof and a mating connector connectable therewith.

According to another aspect of the invention, there is provided a method of assembling a lever-equipped connector, in particular according to the above aspect or a particular embodiment thereof, to a mating connector, comprising: providing a lever-equipped connector comprising a connector housing having a lever displaceably provided thereon, the lever-equipped connector being connectable to the mating connector if the lever is displaced from a connection initial position to a connection position; wherein a gear mechanism including an inner gear is formed in the lever such that teeth are substantially arrayed along a lever displacement direction and an outer gear is formed in the lever to integrally move with the inner gear, meshing the inner gear with a first gear movably provided in the connector, the first gear including a first engaging piece to be meshed and engageable or engaged with a first engaged portion of the mating connector when the first gear is moved by the inner gear in an operation of locating the lever at the connection position, and meshing the outer gear with a second gear movably provided in the connector housing, the second gear including a second engaging piece to be meshed and engageable or engaged with a second engaged portion of the mating connector when the second gear is moved by the outer gear in the operation of locating the lever at the connection position.

The present disclosure can make oblique connection to a mating connector less likely to occur and reduce a connector size.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a lever-equipped connector when being connected to a mating connector.

FIG. 2 is a section showing a connected state of the lever-equipped connector.

FIG. 3 is an exploded perspective view of the lever-equipped connector and the mating connector.

FIG. 4 is a perspective view of a lever having a first gear and a second gear removed therefrom.

FIG. 5 is a section along V-V shown in FIG. 2.

FIG. 6 is a perspective view of the lever-equipped connector when viewed from a back side.

FIGS. 7A and 7B are sections showing the operation of a lock mechanism.

FIG. 8 is a perspective view when the lever-equipped connector is attached to the mating connector.

FIGS. 9A to 9C are sections showing the operation of a gear mechanism.

FIGS. 10A and 10B are sections showing the operation of the gear mechanism at a position different from a position in FIGS. 9A to 9C.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Lever-Equipped Connector 1

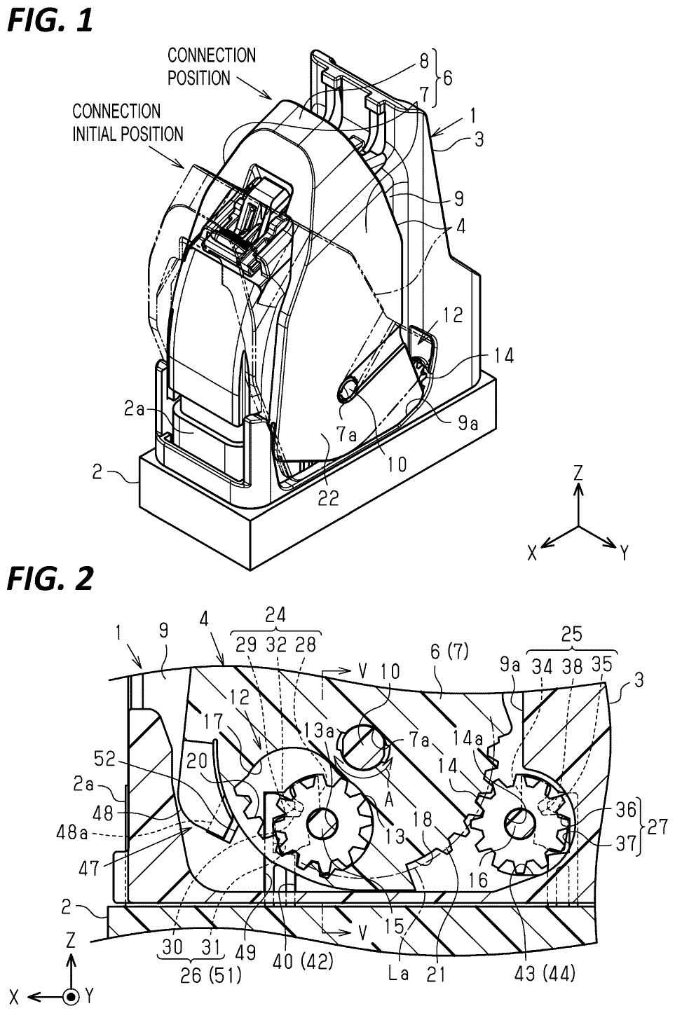

As shown in FIG. 1, a lever-equipped connector 1 is provided with a connector housing 3 to be connected to a mating connector 2 and a lever 4 displaceably or movably (particularly rotatably or pivotably) mounted on the connector housing 3. Each of the lever-equipped connector 1 and the mating connector 2 as a part of a connector assembly is provided with one or more, particularly a plurality of terminals (not shown) to be electrically connected when these connectors are connected.

The lever-equipped connector 1 at least partly is fit into a fitting portion 2a of the mating connector 2. A pair of the lever-equipped connector 1 and the mating connector 2 is, for example, for vehicle.

The lever 4 particularly takes two positions, i.e. a connection initial position before being displaced (particularly rotated or pivoted) and a connection position where the lever 4 is arranged by being displaced (particularly rotated or pivoted) in or along a connection direction from the connection initial position.

In the lever-equipped connector 1, the mating connector 2 and the connector housing 3 particularly substantially are completely connected by displacing (particularly rotating or pivoting) the lever 4 from the connection initial position toward or to the connection position. One of the lever-equipped connector 1 and the mating connector 2 is a male connector and the other is a female connector.

### Lever 4

As shown in FIG. 1, the lever 4 includes a lever body 6 forming a body part of the lever 4. The lever body 6 includes one or more, particularly a pair of side walls 7 and particularly a coupling wall 8 at least partly coupling the pair of side walls 7. The one or more, particularly the pair of side walls 7 are arranged in one or more housing recesses 9a provided or recessed in (particularly one or more side parts 9 of) the connector housing 3.

One or more shaft portions 10 formed on (particularly the side part(s) 9 of) the connector housing 3 are displaceably (particularly rotatably or pivotably) fit or inserted in one or more shaft holes 7a of the one or more, particularly pair of side walls 7.

The lever 4 is or can be displaced (particularly rotated or pivoted) from the connection initial position towards or to the connection position particularly by being rotated about the shaft portions 10.

Specifically, an angle of rotation when the lever 4 is rotated or pivoted from the connection initial position to the connection position is, for example, set to between about 20° and 45°, e.g. to about 30°.

### Gear Mechanisms 12

As shown in FIG. 2, the lever-equipped connector 1 is provided with one or more gear mechanisms 12 for particularly substantially completely connecting the lever-equipped connector 1 being connected by being interlocked with the lever 4 displaced (particularly rotated or pivoted) from the connection initial position towards or to the connection position. The gear mechanisms 12 of this example are provided for both of the pair of side walls 7 of the lever 4.

### First Gear 13 and Second Gear 14

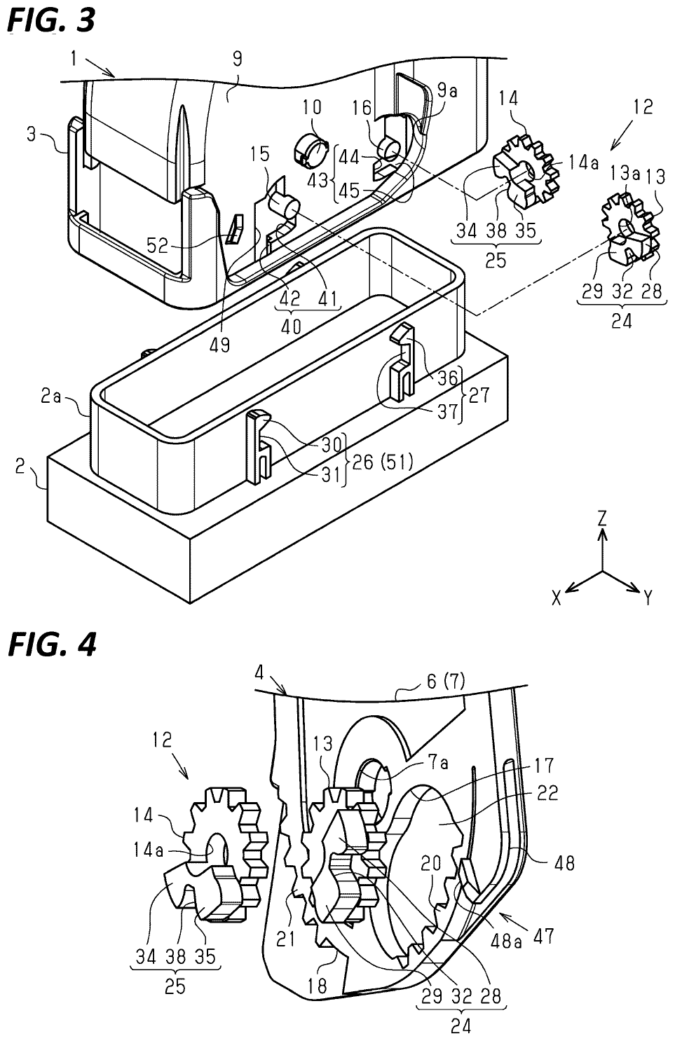

As shown in FIG. 3, the gear mechanism 12 particularly includes a first gear 13 and a second gear 14 rotatably or pivotably mounted in the connector housing 3. The first gear 13 is rotatably or pivotably mounted on a first gear shaft 15 formed on the side part 9 of the connector housing 3.

The first gear shaft 15 particularly at least partly is inserted into a hole portion 13a formed in an intermediate portion (particularly substantially a center) of the first gear 13.

The second gear 14 is rotatably or pivotably mounted on a second gear shaft 16 formed on the side part 9 of the connector housing 3 and/or particularly paired with the first gear shaft 15.

The second gear shaft 16 particularly at least partly is inserted into a hole portion 14a formed in an intermediate portion (particularly substantially a center) of the second gear 15.

The first and second gears 13, 14 particularly are formed into the substantially same gear shape.

The second gear shaft 16 is arranged at such a position that a distance from the shaft portion 10 particularly is longer than a distance between the shaft portion 10 and the first gear shaft 15.

Note that although in the present example the gear mechanisms 12 are provided on both of the pair of side walls 7 of the lever 4, i.e. on both front and back sides of the plane of FIG. 3, only the gear mechanism 12 on the front side of the plane of FIG. 3 is described to simplify description in the case of this example.

As shown in FIG. 4, the first gear 13 particularly at least partly is accommodated in a first recess 17 formed in the lever 4.

The first recess 17 of this example particularly is arranged in the inner surface of the side wall 7 of the lever 4 and/or formed not to penetrate through the side wall 7.

The second gear 14 particularly at least partly is accommodated in a second recess 18 substantially arranged at a position of a corner part of the lever 4 in the inner surface of the side wall 7 of the lever 4.

The side wall 7 is arranged laterally to the second recess 18 of this example.

### Inner Gear 20 and Outer Gear 21

As shown in FIG. 2, the gear mechanism 12 includes an inner gear 20 formed in the lever 4 such that teeth are arrayed along a displacement direction (particularly lever rotation or pivoting direction) see the direction of an arrow A of FIG. 2.

The inner gear 20 particularly is formed on the inner peripheral surface of the first recess 17 for at least partly accommodating the first gear 13.

The inner gear 20 particularly is meshed with the first gear 13 displaceably (particularly rotatably or pivotably) mounted in the connector housing 3.

A gear ratio of the first gear 13 and the inner gear 20 is, for example, set such that the first gear 13 is displaced (particularly rotated or pivoted) by about 70 to 80° in relation to the displacement (particularly rotation or pivotal movement) of e.g. about 30° of the lever 4.

The gear mechanism 12 includes an outer gear 21 formed in the lever 4 to integrally or unitarily move (particularly rotate or pivot) with the inner gear 20.

The outer gear 21 particularly is formed at a position near the shaft portion 10 on the inner peripheral surface of the second recess 18 for at least partly accommodating the second gear 14.

The outer gear 21 particularly is so formed that a tooth pitch thereof substantially is equal to a tooth pitch (e.g. a tooth size and tooth number) of the inner gear 20.

The outer gear 21 particularly is meshed with the second gear 14 displaceably (particularly rotatably or pivotably) mounted in the connector housing 3.

A gear ratio of the second gear 14 and the outer gear 21 is, for example, set to be the substantially same as that of the first gear 13 and the inner gear 20.

The inner and outer gears 20, 21 particularly are arranged on a line of the same movement (particularly rotation or pivoting) track when the lever 4 is displaced (particularly rotated or pivoted).

When the lever 4 is displaced (particularly rotated or pivoted), the inner and outer gears 20, 21 are respectively displaced (particularly rotated or pivoted) in substantially opposite directions.

### Reinforcing Portion 22

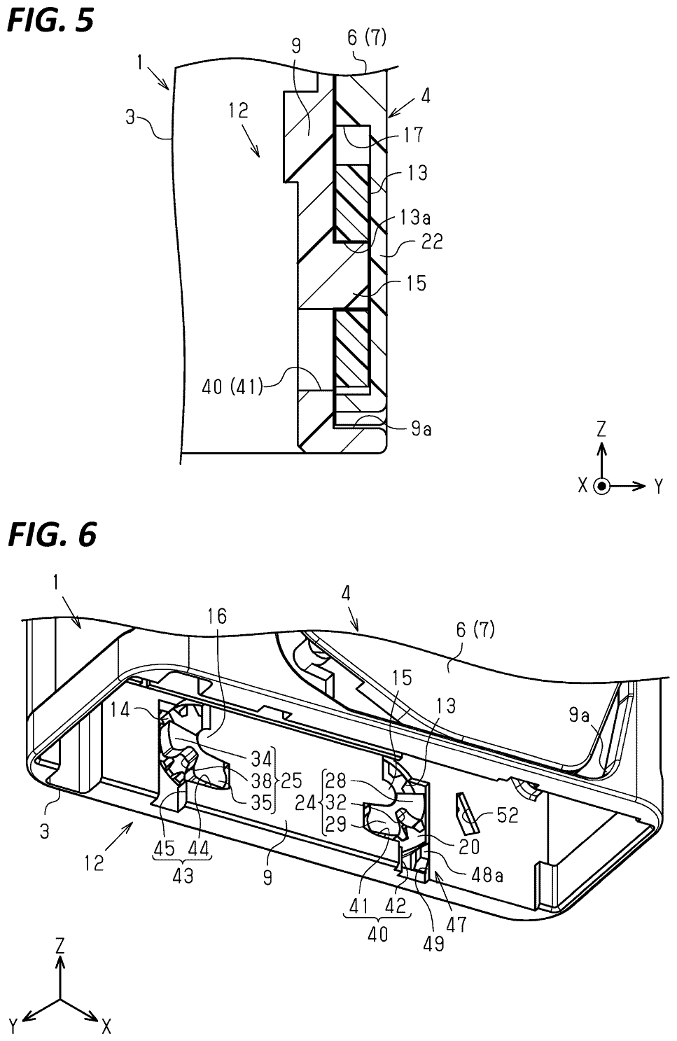

As shown in FIG. 5, the lever 4 particularly includes at least one reinforcing portion 22 formed for the strength of the inner gear 20.

The reinforcing portion 22 particularly is formed to at least partly couple the inner gear 20 to the lever body 6 on the side of the first gear 13. The reinforcing portion 22 of this example forms a part of the side wall 7 of the lever 4.

As just described, the reinforcing portion 22 particularly is also a side plate of the lever 4. Further, the reinforcing portion 22 of this example also serves as a wall of the first recess 17 for at least partly accommodating the first gear 13.

### First Engaging Piece 24 and Second Engaging Piece 25

As shown in FIGS. 3 and 4, the gear mechanism 12 particularly includes a first engaging piece 24 on the first gear 13 and/or a second engaging piece 25 on the second gear 14.

As shown in FIG. 3, a first engaged portion 26 to be engaged with the first engaging piece 24 and/or a second engaged portion 27 to be engaged with the second engaging piece 25 particularly are formed on a side surface of the fitting portion 2a of the mating connector 2.

As just described, the first engaging piece 24 and the first engaged portion 26 particularly are paired, and/or the second engaging piece 25 and the second engaged portion 27 particularly are paired.

The first engaging piece 24 particularly is formed inside the first gear 13.

Specifically, the first engaging piece 24 includes a first projection 28 and a second projection 29 arranged to substantially face each other in a displacement (particularly rotation or pivoting) direction of the first gear 13. The first and second projections 28, 29 are, for example, formed into a substantially fan shape.

The first and second projections 28, 29 particularly are arranged apart by a specified (predetermined or predeterminable) angle along the displacement (particularly rotation or pivoting) direction of the first gear 13.

The first engaged portion 26 particularly includes a projecting portion 30 arranged at a position near an opening of the fitting portion 2a of the mating connector 2 and/or a recessed portion 31 formed at a position lower than the projecting portion 30.

A gap between the first and second projections 28, 29 particularly serves as a recess 32, in which the projecting portion 30 of the first engaged portion 26 is arranged.

The second engaging piece 25 particularly least partly is formed inside the second gear 14.

The second engaging piece 25 particularly includes a third projection 34 and/or a fourth projection 35 similar to the first and second projections 28, 29 of the first engaging piece 24.

The second engaged portion 27 particularly includes a projecting portion 36 and/or a recessed portion 37 similar to the projecting portion 30 and the recessed portion 31 of the first engaged portion 26.

A gap between the third and fourth projections 34, 35 particularly serves as a recess 38, in which the projecting portion 36 of the second engaged portion 27 at least partly is arranged.

The first and second projections 28, 29 of the first gear 13 and/or the third and fourth projections 34, 35 of the second gear 14 particularly substantially are symmetrically arranged in an orthogonal direction (X-axis direction of FIG. 3 and the like) to the shaft portion 10 of the lever 4.

Similarly, the first and second engaged portions 26, 27 particularly are also substantially symmetrically arranged in the orthogonal direction (X-axis direction of FIG. 3 and the like) to the shaft portion 10 of the lever 4.

The projecting portion 30 and the recessed portion 31 of the first engaged portion 26 and the projecting portion 36 and the recessed portion 37 of the second engaged portion 27 particularly substantially are arranged to face each other.

In the gear mechanism 12, the first engaging piece 24 is meshed and engaged with (particularly an inner side of) the first engaged portion 26 and the second engaging piece 25 is meshed and engaged with (particularly an inner side of) the second engaged portion 27 when the lever 4 is operated to the connection position.

Specifically, if the first gear 13 moves (particularly rotates or pivots) according to the movement (particularly rotation or pivoting) of the lever 4, the projecting portion 30 of the first engaged portion 26 is meshed and engaged between the first and second projections 28, 29.

Further, if the second gear 14 moves (particularly rotates or pivots) according to the movement (particularly rotation or pivoting) of the lever 4, the projecting portion 36 of the second engaged portion 27 is meshed and engaged between the third and fourth projections 34, 35.

As shown in FIG. 6, the first engaging piece 24 particularly at least partly is arranged inside a first opening 40 formed in the side part 9 of the connector housing 3.

The first opening 40 particularly includes at least one first groove 41 serving as a space for a movement of the first engaging piece 24 and/or at least one second groove 42 serving as a space for the arrangement of the first engaged portion 26 when the connector housing 3 is connected to the mating connector 2.

When the lever 4 is at the connection initial position, the first projection 28 of the first engaging piece 24 is located in the second groove 42 and/or the second projection 29 of the first engaging piece 24 is located on the back of the first groove 41.

The second engaging piece 25 particularly at least partly is arranged inside a second opening 43 formed adjacent to the first opening 40 in (particularly the side part 9 of) the connector housing 3.

The second opening 43 particularly is arranged substantially side by side with the first opening 40 in a direction (X-axis direction of FIG. 6) intersecting a lever axial direction (Y-axis direction of FIG. 6).

The second opening 43 particularly includes a third groove 44 and/or a fourth groove 45, similarly to the first opening 40.

The first and second openings 40, 43 are symmetrically shaped in the direction (X-axis direction of FIG. 6) intersecting the lever axial direction (Y-axis direction of FIG. 6).

### Lock Mechanism 47

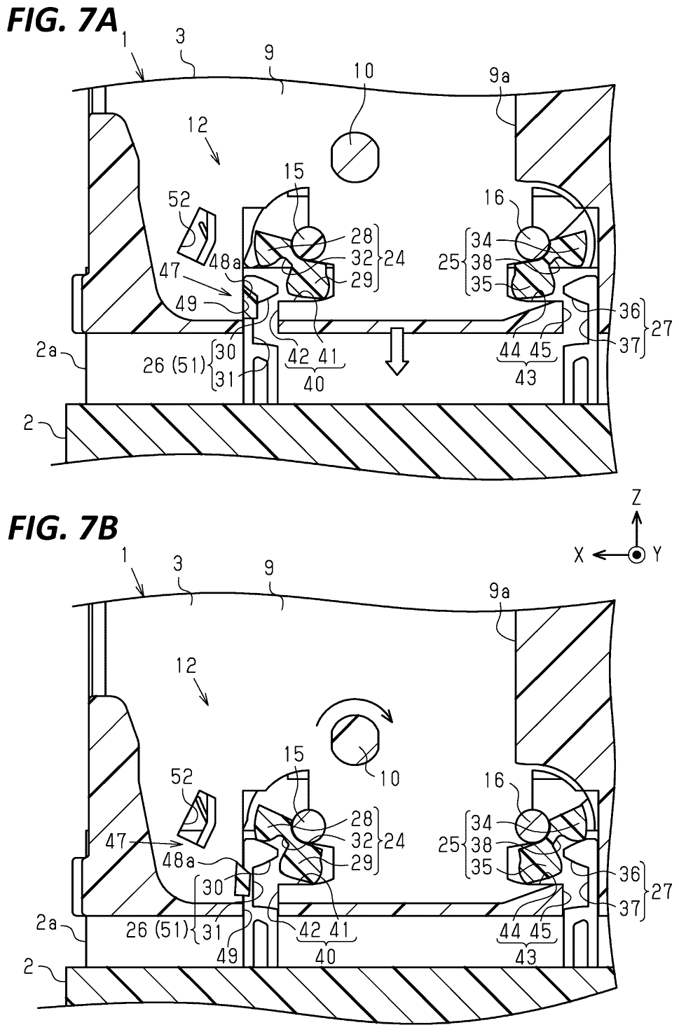

As shown in FIGS. 7A and 7B, the lever-equipped connector 1 particularly is provided with at least one lock mechanism 47 for locking the lever 4 to the connector housing 3 when the lever 4 is operated to the connection position.

The lock mechanism 47 particularly includes at least one lock portion 48 (see FIG. 4 and the like) formed on or in the lever 4.

The lock portion 48 particularly is a resilient piece formed by forming a slit in the side wall 7 in (particularly a corner part of) the side wall 7 of the lever 4 (see FIG. 4 and the like).

A projection 48a particularly is formed on the tip of the lock portion 48.

The lock mechanism 47 particularly includes at least one lock engaging portion 52 formed in the connector housing 3.

The lock engaging portion 52 particularly is a hole or recess formed in (particularly the side part 9 of) the connector housing 3.

The lock mechanism 47 specifically locks the movement (particularly rotation or pivoting) of the lever 4 by the lock portion(s) 48 of the lever 4 engaging the lock engaging portion(s) 52 of the connector housing 3 when the lever 4 is operated to the connection position.

In the case of this example, the projection 48a of the lock portion 48 particularly is engaged with the lock engaging portion 52 of the connector housing 3.

In this way, the lever 4 is held or positioned at the connection position.

The lock mechanism 47 particularly has a position holding function for holding the lever 4 at the connection initial position before the lever-equipped connector 1 is connected to the mating connector 2.

In this case, the lock mechanism 47 particularly includes at least one position holding portion 49 formed in the connector housing 3 to hold the lever 4 at the connection initial position.

The position holding portion 49 particularly is a side part of the second groove 42 of the first opening 40.

The lock mechanism 47 particularly is in a position holding state by the engagement of the projection 48a of the lock portion 48 with the position holding portion 49 of the connector housing 3 when the connector housing 3 is not connected to the mating connector 2.

When the lock mechanism 47 is in the position holding state, the lever 4 particularly is held at the connection initial position.

The mating connector 2 includes at least one releasing portion 51 for releasing the position holding state of the lock mechanism 47.

The releasing portion 51 of this example is the first engaged portion 26 formed on the side surface of the fitting portion 2a.

The lock mechanism 47 particularly enables the lever 4 to move (particularly rotate or pivot) to the connection position by releasing a locking state of the lock portion 48 by the releasing portion 51 of the mating connector 2 in the process of connecting the connector housing 3 to the mating connector 2.

The releasing portion 51 particularly releases the position holding state, for example, by lifting or displacing the projection 48a of the lock portion 48 in the process of connecting the connector housing 3 to the mating connector 2.

### Functions

Next, functions of the lever-equipped connector 1 (and of the respective connector assembly) of this embodiment are described.

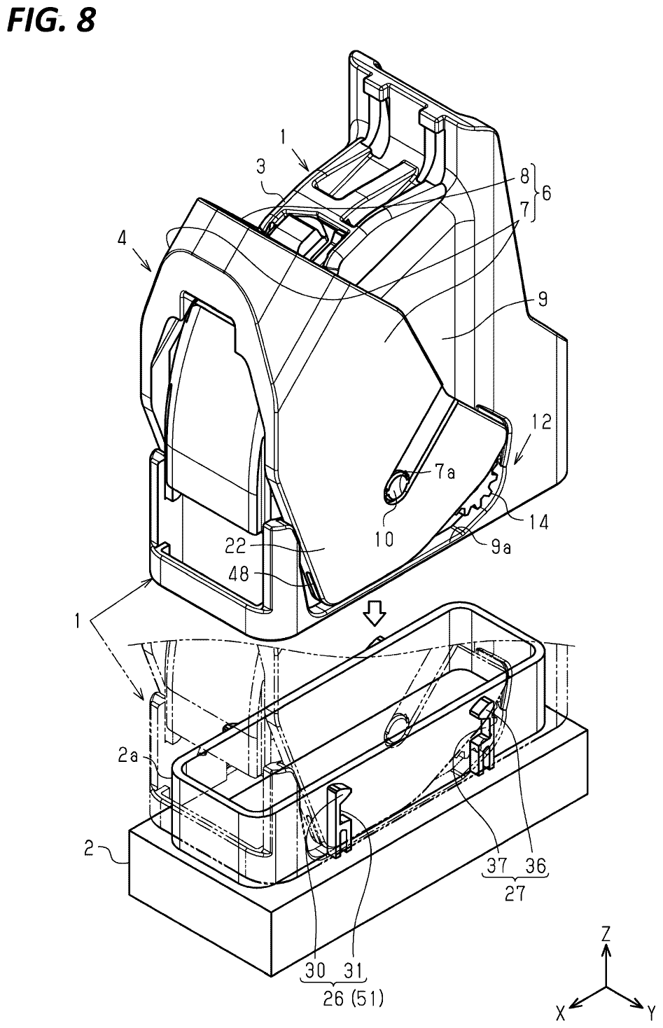

As shown in FIG. 8, the lever-equipped connector 1 particularly is positioned to substantially face the fitting portion 2a of the mating connector 2 with the lever 4 arranged at the connection initial position.

The lever-equipped connector 1 particularly is attached to the mating connector 2 to be fit into the fitting portion 2a (state shown by two-dot chain lines of FIG. 8).

The lever-equipped connector 1 particularly is in a connection initial state without being completely connected to the mating connector 2 when the mating connector 2 specifically is connected with the lever 4 held at the connection initial position.

As shown in FIG. 7A, when the lever-equipped connector 1 particularly is incompletely connected to the mating connector 2, the projection 48a of the lock portion 48 particularly is displaced (e.g. lifted) by the releasing portion 51 (in this example, the first engaged portion 26) of the mating connector 3 to be separated from the position holding portion 49 of the connector housing 3.

In this way, the lock mechanism 47 particularly at least partly enters a position hold released state.

Thus, as shown in FIG. 7B, the displacement (particularly rotation or pivotal movement) of the lever 4 from the connection initial position toward or to the connection position is allowed.

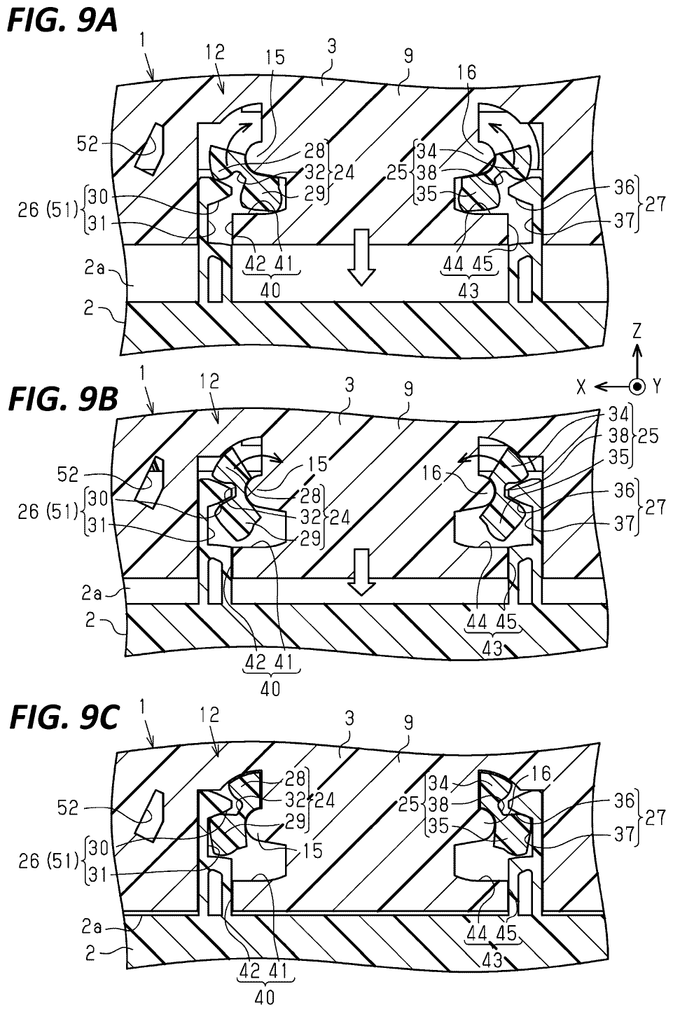

As shown in FIG. 9A, when the lever-equipped connector 1 particularly is in the connection initial state with respect to the mating connector 2, the first gear 13 is not displaced (particularly rotated or pivoted) yet. Thus, the first projection 28 of the first gear 13 particularly substantially contacts the projecting portion 30 of the first engaged portion 26.

Similarly, the third projection 34 of the second gear 14 particularly substantially contacts the projecting portion 36 of the second engaged portion 27.

As described above, the first projection 28 particularly is interfered by the first engaged portion 26 and/or the third projection 34 particularly is interfered by the second engaged portion 27, whereby the lever-equipped connector 1 is in the connection initial state with respect to the mating connector 2.

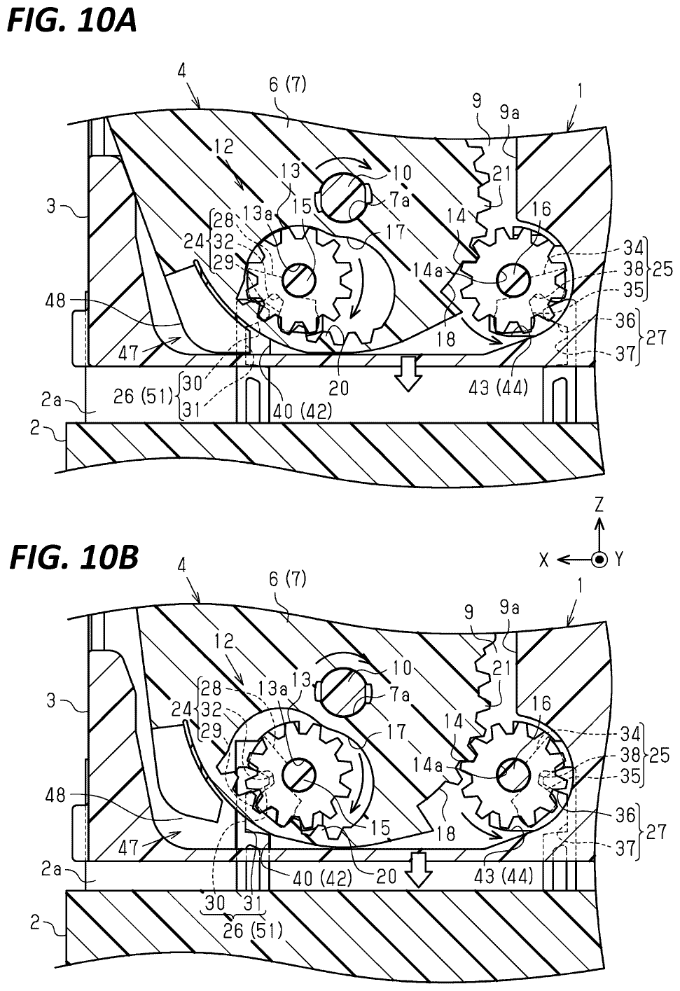

As shown in FIGS. 10A and 10B, if the lever 4 particularly is displaced (particularly rotated or pivoted) from the connection initial position toward or to the connection position, the first and second gears 13, 14 also move (particularly rotate or pivot) according to the movement (particularly rotation or pivoting) of the lever 4.

When the lever 4 is displaced (particularly rotated or pivoted), the first and second gears 13, 14 particularly move (particularly rotate or pivot) in the directions opposite to each other.

Specifically, when the lever 4 particularly is rotated clockwise in figures, the first gear 13 rotates in the same clockwise direction in the figures as the lever 4 and the second gear 14 rotates in a counterclockwise direction opposite to the lever 4.

As shown in FIGS. 9A and 9C, specifically, if the first gear 13 rotates or pivots, the first engaging piece 24 on the back side of the first gear 13 also coaxially rotates or pivots.

In this way, the projecting portion 30 of the first engaged portion 26 particularly is meshed with the recess 32 between the first and second projections 28, 29, wherefore a sinking load particularly is generated in a connection direction (white arrow of FIG. 9B) in the connector housing 3.

Further, specifically, if the second gear 14 rotates or pivots, the second engaging piece 25 on the back side of the second gear 14 also coaxially rotates or pivots.

In this way, the projecting portion 36 of the second engaged portion 27 particularly is meshed with the recess 38 between the third and fourth projections 34, 35, wherefore a sinking load particularly is generated in the connection direction (white arrow of FIG. 9B) in the connector housing 3.

The gear mechanism 12 particularly generates a sinking load in the connector housing 3 and completely connects the connector housing 3 to the mating connector 2 when the lever 4 is operated to the connection position.

As just described, the lever-equipped connector 1 moves to sink, thereby being completely connected to the mating connector 2. In this way, the terminal(s) of the lever-equipped connector 1 and the terminal(s) of the mating connector 2 are also completely connected.

In the above way, the lever-equipped connector 1 particularly is assembled with the mating connector 2.

In the case of this example, if the lever 4 is displaced (particularly rotated or pivoted), a pair of driven gears (in this example, the first and second gears 13, 14) following the lever 4 move (particularly rotate or pivot), whereby the first engaging piece 24 of the first gear 13 is engaged with the first engaged portion 26 of the mating connector 2 and/or the second engaging piece 25 of the second gear 14 is engaged with the second engaged portion 27 of the mating connector 2.

Thus, it is, for example, not necessary to mesh one driven gear with the lever 4 and provide engaging pieces on these.

As just described, the gear mechanism 12 of this example completely connects the connector housing 3 to the mating connector 2 by providing the engaging pieces (particularly first and second engaging pieces 24, 25) on the pair of driven gears (particularly first and second gears 13, 14) following the lever 4 and engaging these engaging pieces with the engaged portions (first and second engaged portions 26, 27) of the mating connector 2.

Thus, the engaging pieces particularly are both provided on the driven gears in the connector housing 3, wherefore connection loads hardly deviate.

One of the pair of driven gears (particularly first and second gears 13, 14) of this example needs to move (particularly rotate or pivot) in the same direction as the lever 4 and the other needs to move (particularly rotate or pivot) in the substantially opposite direction with respect to the operation (particularly rotation or pivoting) of the lever 4.

In the case of this example, the lever 4 particularly is provided with the inner gear 20 and the first gear 13 is meshed with this inner gear 20. Thus, a part of the lever 4 is utilized as an arrangement space for the first gear 13, wherefore the lever-equipped connector 1 can be reduced in size.

In the case of this example, the gears of the lever 4 and the first and second gears 13, 14 particularly are arranged substantially side by side in an orthogonal direction (X-axis direction of FIG. 2 and the like) to the lever axial direction (Y-axis direction of FIG. 2 and the like). Thus, the first and second gears 13, 14 are arranged across a specified (predetermined or predeterminable) interval. In this way, even if a dimension of the connector housing 3 (mating connector 2) in the orthogonal direction to the lever axial direction is increased, a pair of the first engaging piece 24 and the first engaged portion 26 and/or a pair of the second engaging piece 25 and the second engaged portion 27 can be respectively arranged at positions particularly near end parts in the orthogonal direction to the lever axial direction.

Thus, the connector housing 3 particularly can be at least partly sandwiched by the mating connector 2 from both ends in the orthogonal direction to the lever axial direction, wherefore the inclination of the connection can be made less likely to occur without depending on the dimension in this direction.

Further, in the case of a structure for engaging the engaging pieces and the engaged portions by moving (particularly rotating or pivoting) the gears by the displacement (particularly rotation or pivoting) of the lever 4, movement (particularly rotation or pivoting) amounts of the engaging pieces can be increased by the gears. Thus, even if an operation amount of the lever 4 is small, movement (particularly rotation or pivoting) amounts of the gears can be increased.

Therefore, a displacement (particularly rotation or pivoting) operation amount of the lever 4 can be suppressed to be small, which consequently further contributes to the size reduction of the lever-equipped connector 1, as compared to a connector not using a gear structure.

### Effects of Embodiment

According to the above embodiment, the following effects can be obtained.

The lever-equipped connector 1 is connected or connectable to the mating connector 2 of a connector assembly if the lever 4 displaceable (particularly rotatably or pivotably) provided on or to the connector housing 3 to be connected to the mating connector 2 is operated or displaced (particularly rotated or pivoted) from the connection initial position toward or to the connection position.

The gear mechanism 12 particularly includes the inner gear 20 formed in or on the lever 4 such that the teeth are arrayed substantially along the lever operation or displacement direction (direction of the arrow A of FIG. 2), particularly lever rotation direction or lever pivoting direction, and the outer gear 21 formed in or on the lever 4 to integrally move (particularly rotate or pivot) with the inner gear 20.

In the gear mechanism 12, the inner gear 20 particularly is meshed with the first gear 13 movably (particularly rotatably or pivotably) provided in the connector housing 3 and/or the outer gear 21 particularly is meshed with the second gear 14 movably (particularly rotatably or pivotably) provided in the connector housing 3.

The first gear 13 particularly includes the first engaging piece 24 to be meshed and engaged with the inner side of the first engaged portion 26 of the mating connector 2 when the lever 4 is operated or displaced (particularly rotated or pivoted) toward or to the connection position.

The second gear 14 particularly includes the second engaging piece 25 to be meshed and engaged with the inner side of the second engaged portion 27 of the mating connector 2 when the lever 4 is operated or displaced (particularly rotated or pivoted) toward or to the connection position.

According to this configuration, both the first engaging piece 24 to be engaged with the first engaged portion 26 of the mating connector 2 and/or the second engaging piece 25 to be engaged with the second engaged portion 27 of the mating connector 2 are formed on the driven gear(s) (particularly first and second gears 13, 14) particularly configured to co-rotate with the lever 4.

Thus, when the lever 4 is displaced (particularly rotated or pivoted) toward or to the connection position, a difference in rotation load specifically is hardly generated between the first engaging piece 24 engaged with the first engaged portion 26 by moving (particularly rotating or pivoting) together with the first gear 13 and/or the second engaging piece 25 engaged with the second engaged portion 27 by moving (particularly rotating or pivoting) together with the second gear 14.

In this way, the first and second engaging pieces 24, 25 particularly are engaged with the mating partners with substantially equivalent loads, wherefore the lever-equipped connector 1 is hardly connected in an inclined state to the mating connector 2.

The first and second gears 13, 14 particularly need to be moved (particularly rotated or pivoted) in the directions substantially opposite to each other to engage the first engaging piece 24 with the inner side of the first engaged portion 26 and/or engage the second engaging piece 25 with the inner side of the second engaged portion 27.

At this time, if the first and second gears 13, 14 particularly are both configured to be meshed with outer teeth of the lever 4, either one of the first and second gears 13, 14 needs to be meshed with the outer teeth via another gear and a concern for enlargement arises. On the other hand, in the case of this configuration, the first gear 13 particularly is meshed with the inner gear 20 of the lever 4. Thus, the number of gears is not increased, wherefore the lever-equipped connector 1 can be reduced in size. In the above way, oblique connection to the mating connector 2 can be made less likely to occur and the connectors can be reduced in size.

The first engaging piece 24 particularly at least partly is arranged inside the first gear 13. The second engaging piece 25 particularly at least partly is arranged inside the second gear 14.

According to this configuration, an engaged part of the first engaging piece 24 and the first engaged portion 26 can be covered by a meshed part of the inner gear 20 of the lever 4 and the first gear 13, in other words, by the side wall 7 of the lever 4.

Similarly, an engaged part of the second engaging piece 25 and the second engaged portion 27 particularly can be covered by a meshed part of the outer gear 21 of the lever 4 and the second gear 14, in other words, by the side wall 7 of the lever 4.

Thus, a connected part of the mating connector 2 and the connector housing 3 can be covered by the side wall 7 of the lever 4, wherefore the intrusion of an external matter or water or fluid into the connector can be made less likely to occur.

The first gear 13 particularly at least partly is accommodated in the first recess 17 formed in (particularly the inner surface of) the lever 4.

The second gear 14 particularly at least partly is accommodated in the second recess 18 formed in (particularly the inner surface of) the lever 4.

According to this configuration, sizes in the lever axial direction (Y-axis direction of FIG. 1 and the like) can be reduced, therefore contributing to the size reduction of the lever-equipped connector 1 in this direction.

The lever 4 particularly includes the at least one reinforcing portion 22 formed to couple the inner gear 20 to the lever body 6 on the side of the first gear 13 to improve the strength of the inner gear 20.

According to this configuration, since the strength of the inner gear 20 can be enhanced by the reinforcing portion 22, an abnormality can be made less likely to occur in the inner gear 20.

The lever-equipped connector 1 particularly is provided with the lock mechanism 47 for locking the displacement (particularly rotation or pivoting) of the lever 4 by the lock portion(s) 48 of the lever 4 engaging the lock engaging portion(s) 52 of the connector housing 3 when the lever 4 is operated to the connection position.

The lock portion 48 particularly holds or positions the lever 4 at the connection initial position particularly by being engaged with the position holding portion 49 of the connector housing 3 when the connector housing 3 is not connected to the mating connector 2.

The lock portion 48 enables the lever 4 to be displaced (particularly rotated or pivoted) to the connection position particularly by being released from the position holding state by the position holding portion 49 by the releasing portion 51 of the mating connector 2 in the process of connecting the connector housing 3 to the mating connector 2.

According to this configuration, before the lever-equipped connector 1 particularly is connected to the mating connector 2, the lever 4 can be held at the connection initial position by the lock mechanism 47.

Thus, before the lever-equipped connector 1 is attached to the mating connector 2, the lever 4 is hardly accidentally displaced (particularly rotated or pivoted) in the connection direction.

This contributes to an improvement in workability in connecting the lever-equipped connector 1 to the mating connector 2.

Accordingly, to provide a lever-equipped connector capable of making oblique connection to a mating connector less likely to occur and reducing a connector size, there is provided a gear mechanism 12 provided in a lever-equipped connector 1 includes an inner gear 20 and an outer gear 21 formed in a lever. In the gear mechanism 12, the inner gear 20 is meshed with a first gear 13 rotatably or pivotably provided in a connector housing 3 and the outer gear 21 is meshed with a second gear 14 rotatably or pivotably provided in the connector housing 3. The first gear 13 includes a first engaging piece 24 to be meshed and engaged with an inner side of a first engaged portion 26 of a mating connector 2 when the lever 4 is rotated to a connection position. The second gear 14 includes a second engaging piece 25 to be meshed and engaged with an inner side of a second engaged portion 27 of the mating connector 2 when the lever 4 is rotated to the connection position.

### Other Embodiments

Note that this embodiment can be modified and carried out as follows. This embodiment and the following modifications can be carried out in combination with each other without technically contradicting.
The gear mechanism 12 may be provided only on one side in the lever axial direction.
The first and second gears 13, 14 are not limited to gears having teeth on an entire periphery and may have teeth only in a part.
The first and second gears 13, 14 may be shaped to have different tooth pitches.
The first and second gears 13, 14 only have to be arranged between the side wall 7 of the lever 4 and the side part 9 of the connector housing 3.
The inner gear 20 and the outer gear 21 may be arranged on different lines, other than on the line of the same movement (particularly rotation or pivoting) track La.
The releasing portion 51 particularly is not limited to being the first engaged portion 26. For example, the releasing portion 51 may be formed by a member different from the first engaged portion 26.
The lever-equipped connector 1 may include a CPA (connection position assurance) member for assuring a connected state of the mating connector 2 and the connector housing 3.
The lock mechanism 47 may be omitted.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A lever-equipped connector, comprising:
a connector housing to be connected to a mating connector;
a lever displaceably provided on the connector housing, the lever-equipped connector being connectable to the mating connector if the lever is displaced from a connection initial position to a connection position; and
a gear mechanism including an inner gear formed in the lever such that teeth substantially are arrayed along a lever displacement direction and an outer gear formed in the lever to integrally move with the inner gear, the inner gear being meshed with a first gear movably provided in the connector housing, the outer gear being meshed with a second gear movably provided in the connector housing,
the first gear including a first engaging piece to be meshed and engageable with a first engaged portion of the mating connector when the first gear is moved by the inner gear in an operation of locating the lever at the connection position, and
the second gear including a second engaging piece to be meshed and engageable with a second engaged portion of the mating connector when the second gear is moved by the outer gear in the operation of locating the lever at the connection position.

2. The lever-equipped connector according to claim 1, wherein:
the first engaging piece is to be meshed and engageable with an inner side of the first engaged portion of the mating connector when the first gear is moved by the inner gear in an operation of locating the lever at the connection position, and/or
the second engaging piece to be meshed and engageable with an inner side of the second engaged portion of the mating connector when the second gear is moved by the outer gear in the operation of locating the lever at the connection position.

3. The lever-equipped connector according to claim 1, wherein:
the first engaging piece is arranged inside the first gear, and/or
the second engaging piece is arranged inside the second gear.

4. The lever-equipped connector according to claim 1, wherein:
the first gear at least partly is accommodated in a first recess formed in an inner surface of the lever, and/or
the second gear at least partly is accommodated in a second recess formed in the inner surface of the lever.

5. The lever-equipped connector according to claim 1, wherein the lever includes at least one reinforcing portion formed to couple the inner gear to a lever body on a side of the first gear to improve strength of the inner gear.

6. The lever-equipped connector according to claim 1, comprising at least one lock mechanism for locking displacement of the lever by at least one lock portion of the lever being engageable with a lock engaging portion of the connector housing when the lever is operated to the connection position.

7. The lever-equipped connector according to claim 6, wherein the lock portion is engaged with a position holding portion of the connector housing to hold the lever at the connection initial position when the connector housing is not connected to the mating connector and enables the lever to be displaced to the connection position by being released from a position holding state by the position holding portion by a releasing portion of the mating connector in the process of connecting the connector housing to the mating connector.

8. The lever-equipped connector according to claim 1, further including a connection position assurance member for assuring a connected state of the connector housing with the mating connector.

9. A connector assembly comprising a lever-equipped connector according to claim 1 and a mating connector connectable therewith.

10. A method of assembling a lever-equipped connector to a mating connector, comprising:
providing a lever-equipped connector comprising a connector housing having a lever displaceably provided thereon, the lever-equipped connector being connectable to the mating connector if the lever is displaced from a connection initial position to a connection position; wherein a gear mechanism including an inner gear is formed in the lever such that teeth substantially are arrayed along a lever displacement direction and an outer gear is formed in the lever to integrally move with the inner gear,
meshing the inner gear with a first gear movably provided in the connector housing, the first gear including a first engaging piece to be meshed and engageable with a first engaged portion of the mating connector when the first gear is moved by the inner gear in an operation of locating the lever at the connection position, and
meshing the outer gear with a second gear movably provided in the connector housing, the second gear including a second engaging piece to be meshed and engageable with a second engaged portion of the mating connector when the second gear is moved by the outer gear in the operation of locating the lever at the connection position.
